(19) United States
(12) Patent Application Publication
(10) Pub. No.: US 2020/0042231 A1
(43) Pub. Date: Feb. 6, 2020

(54) Dynamic Data Paths In Flash Drives

(71) Applicant: Burlywood, Inc., Longmont, CO (US)

(72) Inventors: David Christopher Pruett, Longmont, CO (US); Christopher Bergman, Erie, CO (US)

(73) Assignee: Burlywood, Inc., Longmont, CO (US)

(21) Appl. No.: 16/530,429

(22) Filed: Aug. 2, 2019

Related U.S. Application Data
(60) Provisional application No. 62/713,939, filed on Aug. 2, 2018.

(51) Int. Cl. G06F 3/06

(52) U.S. Cl. CPC G06F 3/0655; G06F 3/0679; G06F 3/0604

(57) ABSTRACT

A storage controller for a storage system includes a host interface, configured to receive data for storage within the storage system, and to transmit data from the storage system to a host system, and one or more storage interfaces, configured to transmit data to storage media, and to receive data from the storage media. The storage controller also includes a plurality of data paths configured to process and transfer data between the host interface and the one or more storage interfaces, the plurality of data paths comprising a first quantity of read data paths configured to interpret data retrieved from the storage media, and a second quantity of write data paths configured to prepare data for storage onto the storage media, and an arbiter configured to dynamically arbitrate access to the one or more storage interfaces by the read data paths and the write data paths.

### RELATED APPLICATIONS

This application hereby claims the benefit of and priority to U.S. Provisional Patent Application No. 62/713,939, titled “DYNAMIC DATA PATHS IN FLASH DEVICES”, filed on Aug. 2, 2018 and which is hereby incorporated by reference in its entirety.

### TECHNICAL FIELD

Aspects of the disclosure are related to data storage and in particular to read and write data paths in flash memory devices.

### TECHNICAL BACKGROUND

Flash non-volatile storage devices are commonly used in computers as high-speed solid-state storage devices. Traditional solid-state storage devices have employed one or more read any write data paths, typically associated one-to-one with a specific flash interface. While simple, it is not always an optimal architecture for specific use cases.

For example, in some use cases read speed may be much more important than write speed, and it may be desirable to have more read data paths available than write data paths. Other use cases may include a need for data paths optimized for specific data encoding, such as error detection and correction.

### Overview

In an embodiment, a storage controller for a storage system is provided.

The storage controller includes a host interface, configured to receive data for storage within the storage system, and to transmit data from the storage system to a host system, and one or more storage interfaces, configured to transmit data to storage media within the storage system and to receive data from the storage media.

The storage controller also includes a plurality of data paths configured to process and transfer data between the host interface and the one or more storage interfaces, the plurality of data paths comprising a first quantity of read data paths configured to interpret data retrieved from the storage media, and a second quantity of write data paths configured to prepare data for storage onto the storage media, and an arbiter configured to dynamically arbitrate access to the one or more storage interfaces by the read data paths and the write data paths.

In another embodiment, a method of operating a storage controller for a storage system is provided. The storage controller comprising a plurality of data paths, the plurality of data paths comprising a first quantity of read data paths configured to interpret data retrieved from a storage media within the storage system, and a second quantity of write data paths configured to prepare data for storage onto the storage media.

The method includes receiving host data from a host system through a host interface, and processing the host data through one of the second quantity of write data paths to produce storage data. The method also includes transferring the storage data to a storage interface for storage in the storage media through an arbiter configured to dynamically arbitrate access to the storage interface by the read data paths and the write data paths.

In a further embodiment, a method of operating a storage controller for a storage system is provided. The storage controller comprising a plurality of data paths, the plurality of data paths comprising a first quantity of read data paths configured to interpret data retrieved from a storage media within the storage system, and a second quantity of write data paths configured to prepare data for storage onto the storage media.

The method includes receiving storage data from the storage media through a storage interface, and transferring the storage data to one of the first quantity of read data paths through an arbiter configured to dynamically arbitrate access to the storage interface by the read data paths and the write data paths. The method also includes processing the storage data through the read data path to produce host data, and transferring the host data to a host system through a host interface.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computer host and data storage system.

FIG. 2 illustrates a prior art data storage system.

FIG. 3 illustrates an example data storage system.

FIG. 4 illustrates an example data storage system.

FIG. 5 illustrates an example data storage system.

FIG. 6 illustrates an example data storage system.

FIG. 7 illustrates an example method for operating a storage controller.

FIG. 8 illustrates a storage controller.

### DETAILED DESCRIPTION

The example embodiments illustrated herein include storage controllers in which the read and write data paths are decoupled from each other and the flash memory interface. Data paths are dynamically connected to the flash interface as needed, allowing the storage controller to trade off read and write bandwidths and hardware size in order to optimize a solution for the specific requirements of a given use case.

Write data paths provide a series of transformations that encode original data in preparation for writing it to the storage media. Typical transformations include randomization, encoding error detection and correction codes, interleaving, and padding. These transformations are typically implemented in hardware.

Read data paths provide a series of transformations that recover original data from the raw bits read from the storage media. Typical transformations include undoing randomization, deinterleaving, detecting and correcting errors, and removing extra padding bits. These transformations are typically implemented in hardware.

While statically assigning a read and write data path to each flash interface provides the maximum bandwidth and flexibility it is also the most expensive solution, in terms of logic resources (gates, power, etc.). This configuration cannot utilize more than 50% of the total number of read and write data paths, as a flash interface engages one or the other, but not both, when interacting with the flash.

Dynamically allocating data paths to flash interfaces enables lower-cost solutions that are tuned to their specific application. The total number of data paths may be lower than the number of flash interfaces, reducing cost, potentially with lower performance. The number of read and write data paths may be different from each other allowing tuning for asymmetric workloads.

Another feature of dynamic data paths is that data paths do not need to possess identical capabilities. For example, some error correction codes may be decoded with either a small, fast, limited decoder or a larger, more powerful decoder. Instead of including a larger, more powerful decoder for each flash interface, an implementation could include only one enhanced read channel with the rest being smaller, cheaper implementations.

An example of an error correction code that could employ more than one decoder is Low-Density Parity Check (LDPC). A given LDPC code could be decoded with hard-decision inputs and include limited precision for its internal state. This limited decoder might suffice for most reads. An alternative would be a decoder that uses soft inputs with enhanced internal precision that provides rarely-needed additional error correction power with a larger, more expensive implementation. The data path with the enhanced decoder might be used only during error recovery.

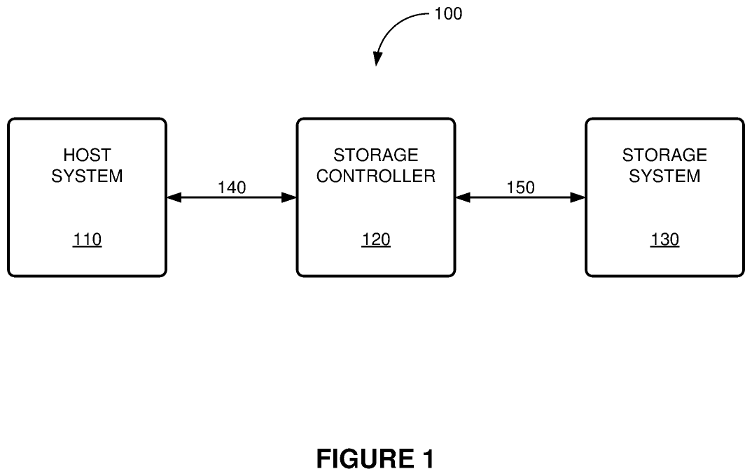

FIG. 1 illustrates computer host and data storage system 100. In this example embodiment, host system 110 sends data to, and receives data from, storage controller 120 for storage in storage system 130. In an example embodiment, storage system 130 comprises flash non-volatile memory, such as NAND memory. NAND memory is just one example, other embodiments of storage system 130 may comprise other types of storage. Storage controller 120 communicates with storage system over link 150, and performs the function of configuring host data received from host system 110 into a format that efficiently uses the memory resources of storage system 130.

Storage controller 120 provides translation between standard storage interfaces and command protocols used by host system 110 to a command protocol and the physical interface used by storage devices within storage system 130.

In this example, storage controller 120 is configured to provide storage data to storage system 130 using a quantity of read data paths and a quantity of write data paths. These quantities of read and write data paths may not be equal in number, depending on the configuration of storage controller 120. For example, in embodiments where read bandwidth is critical, but write bandwidth is not, storage controller 120 may include a larger quantity of read data paths than write data paths.

Additionally, the read and write data paths within storage controller 120 implement error correction code (ECC) encode/decode functions, along with data encoding, data recovery, retry recovery methods, and other processes and methods to optimize data integrity.

Storage controller 120 may take any of a variety of configurations. In some examples, storage controller 120 may be a Field Programmable Gate Array (FPGA) with software, software with a memory buffer, an Application Specific Integrated Circuit (ASIC) designed to be included in a single module with storage system 130, a set of Hardware Description Language (HDL) commands, such as Verilog or System Verilog, used to create an ASIC, a separate module from storage system 130, built in to storage system 130, or any of many other possible configurations.

Host system 110 communicates with storage controller 120 over various communication links, such as communication link 140. These communication links may use the Internet or other global communication networks. Each communication link may comprise one or more wireless links that can each further include Long Term Evolution (LTE), Global System For Mobile Communications (GSM), Code Division Multiple Access (CDMA), IEEE 802.11 WiFi, Bluetooth, Personal Area Networks (PANs), Wide Area Networks, (WANs), Local Area Networks (LANs), or Wireless Local Area Networks (WLANs), including combinations, variations, and improvements thereof. These communication links can carry any communication protocol suitable for wireless communications, such as Internet Protocol (IP) or Ethernet.

Additionally, communication links can include one or more wired portions which can comprise synchronous optical networking (SONET), hybrid fiber-coax (HFC), Time Division Multiplex (TDM), asynchronous transfer mode (ATM), circuit-switched, communication signaling, or some other communication signaling, including combinations, variations or improvements thereof. Communication links can each use metal, glass, optical, air, space, or some other material as the transport media. Communication links may each be a direct link, or may include intermediate networks, systems, or devices, and may include a logical network link transported over multiple physical links.

Storage controller 120 communicates with storage system 130 over link 150. Link 150 may be any interface to a storage device or array. In one example, storage system 130 comprises NAND flash memory and link 150 may use the Open NAND Flash Interface (ONFI) command protocol, or the “Toggle” command protocol to communicate between storage controller 120 and storage system 130. Other embodiments may use other types of memory and other command protocols. Other common low level storage interfaces include DRAM memory bus, SRAM memory bus, and SPI.

Link 150 can also be a higher level storage interface such as SAS, SATA, PCIe, Ethernet, Fiber Channel, Infiniband, and the like. However—in these cases, storage controller 120 would reside in storage system 130 as it has its own controller.

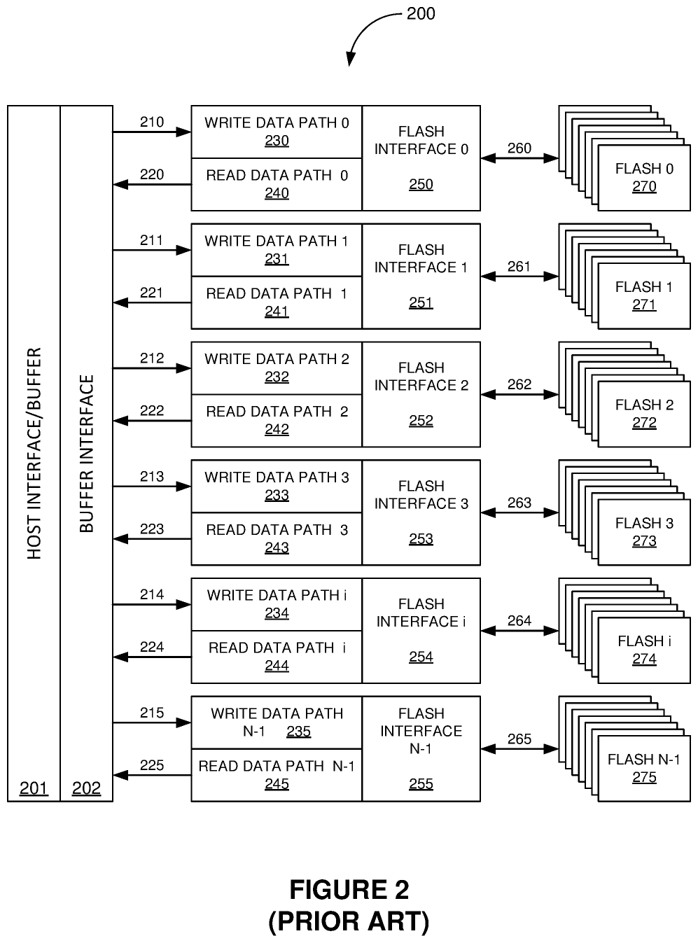

FIG. 2 illustrates a prior art data storage system 200 with identical dedicated read and write data paths for each flash interface. This example system comprises buffer 201, buffer interface 202, a quantity of write data paths 230-235, a quantity of read data paths 240-245, a quantity of flash interfaces 250-255, and a quantity of flash memories 270-275.

In this example, buffer 201 is configured to communicate with a host system, such as host system 110 from FIG. 1. Buffer interface 202 provides outputs to write data paths 0-N−1 (230-235) over links 210-215, and receives inputs from read data paths 0-N−1 (240-245) over links 220-225. Each write data path and read data path is coupled with a corresponding flash interface 0-N−1 (250-255).

In this prior art example, each flash memory module 270-275 is coupled with a corresponding flash interface 250-255 with a link 260-265. Also, each flash memory module 270-275 has a corresponding write data path 230-235 and read data path 240-245. With dedicated data paths, a flash interface 270-275 never waits for access to a data path. However, when using one data path, the other is idle. Thus, at least half the data paths in the system are idle at any time. This solution offers high performance and flexibility but is also expensive.

In some example embodiments, flash interfaces 250-255 use the Open NAND Flash Interface (ONFI) command protocol, or the “Toggle” command protocol to communicate with flash memories 270-275 over links 260-265. The ONFI specification includes both the physical interface and the command protocol of ONFI ports 0 and 1 within flash interfaces 250-255. The interface includes an 8-bit bus (in links 260-265) and enables storage system 200 to perform read, program, erase, and other associated operations to operate flash memories 270-275.

The dynamic data path approach detaches or decouples data paths from the flash interfaces, employing an arbitrated router to dynamically connect data paths to a flash interface. Connectivity between the data paths and flash interfaces is dynamic instead of static which increases flexibility and enables cost reduction.

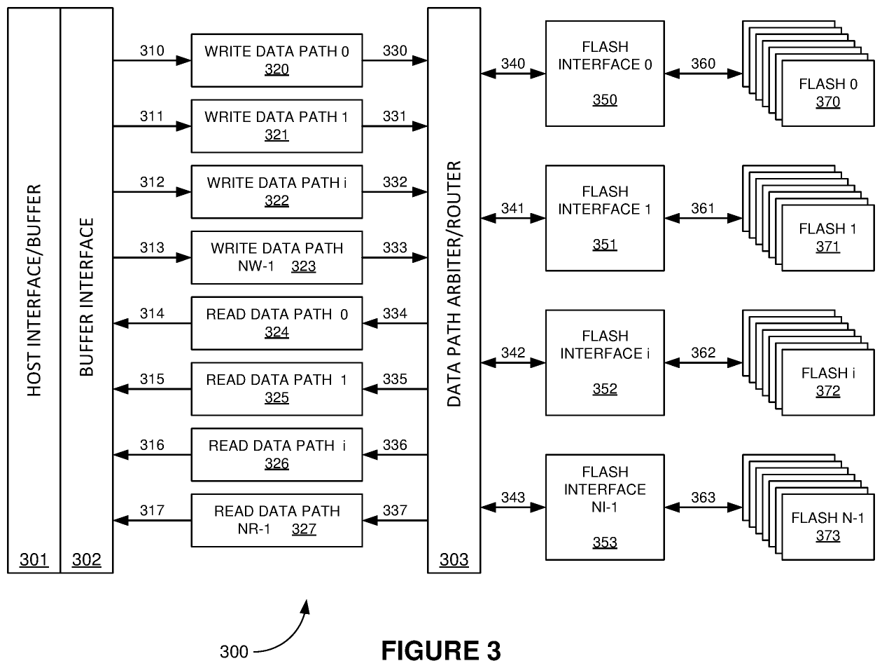

FIG. 3 illustrates an example data storage system 300. In this example, data storage system 300 includes storage media comprising four flash media components 370-373. This example system comprises buffer 301, buffer interface 302, a quantity of write data paths 320-323, a quantity of read data paths 324-327, a data path arbiter/router 303, a quantity of flash interfaces 350-353, and a quantity of flash memories 370-373.

In this example, buffer 301 is configured to communicate with a host system, such as host system 110 from FIG. 1. Buffer interface 302 provides outputs to write data paths 0-NW−1 (320-323) over links 310-313, and receives inputs from read data paths 0-NR−1 (324-327) over links 314-317. Write data paths 0-NW−1 320-323 send data to arbiter 303 over links 330-333, and read data paths 0-NR−1 324-327 receive data from arbiter 303 over links 334-337. Arbiter 303 communicates with flash interfaces 0-NI−1 350-353 over links 340-343. Flash interfaces 0-NI−1 350-353 communicate with flash memory devices 0-N−1 370-373 over links 360-363 respectively.

In other embodiments, any number of flash media components and flash interfaces may be provided within the scope of the present invention. Various forms of storage media can be employed, such as NAND/NOR flash, phase change memory, magnetic random-access memory (MRAM), memristor memory, and the like. In this example embodiment, data storage system 300 includes four media interfaces—flash interfaces 0-NI−1 350-353, each coupled with one of the flash media components—flash 0-N−1 370-373 over links 360-363.

A quantity (NW) of write data paths 320-323 are configured to prepare data for storage onto the storage media, and a quantity (NR) of read data paths 324-327 are configured to interpret data retrieved from the storage media. A data path arbiter/router 303 is included to dynamically arbitrate access to the flash interfaces 350-353 by the plurality of write data paths 230-232 and read data paths 324-327. In some examples, arbiter 303 is configured to provide priority to reads and/or writes from some of the flash interfaces over other flash interfaces.

In this example, the quantity of write data paths (NW) and read data paths (NR) is equal. In other examples, the number and type of read data paths and write data paths may differ. The number and type of read data paths and write data paths can also be dynamically instantiated for access to the storage media.

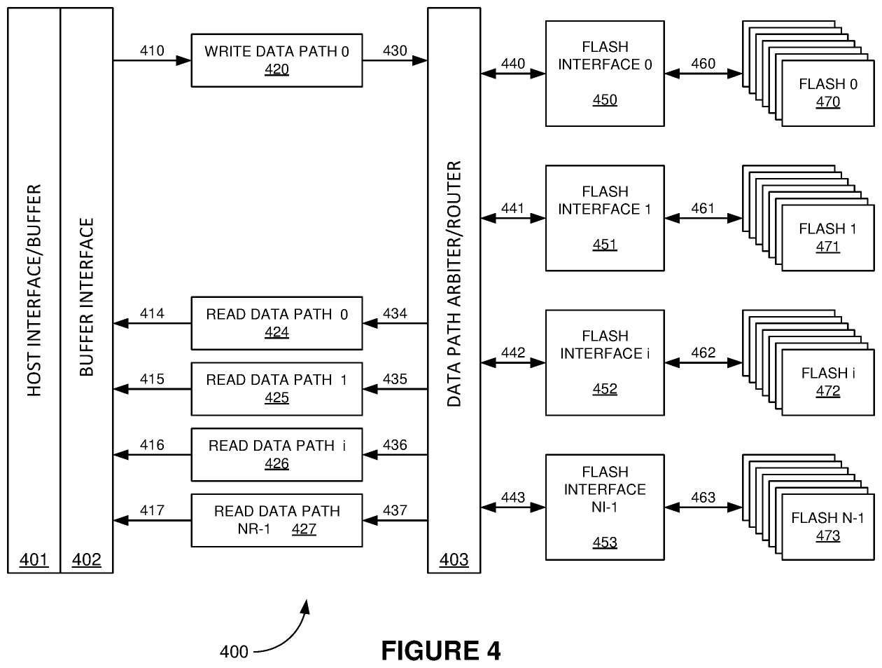

While this example embodiment has four flash interfaces and flash memory devices (NI=N=4), other example embodiments may use any quantity of flash interfaces and flash memory devices. For example, a high-capacity system with reduced performance might use values of NI=N=16, and NR=NW=4, with fewer data paths than flash interfaces. Other examples are illustrated in FIGS. 4-6 and described below.

FIG. 4 illustrates an example data storage system 400. This example embodiment has four flash interfaces and flash memory devices (NI=N=4), but unbalanced quantities of read and write data paths (NW=1, NR=4). This example embodiment may be used in a system where read bandwidth is more important than write bandwidth.

This example system comprises buffer 401, buffer interface 402, a write data path 420, a quantity of read data paths 424-427, a data path arbiter/router 403, a quantity of flash interfaces 450-453, and a quantity of flash memories 470-473.

In this example, buffer 401 is configured to communicate with a host system, such as host system 110 from FIG. 1. Buffer interface 402 provides outputs to write data path 0 320 over link 410, and receives inputs from read data paths 0-NR−1 (424-427) over links 414-417. Write data path 0 420 sends data to arbiter 403 over link 430, and read data paths 0-NR−1 424-427 receive data from arbiter 403 over links 434-437. Arbiter 403 communicates with flash interfaces 0-NI−1 450-453 over links 440-443. Flash interfaces 0-NI−1 450-453 communicate with flash memory devices 0-N−1 470-473 over links 460-463 respectively.

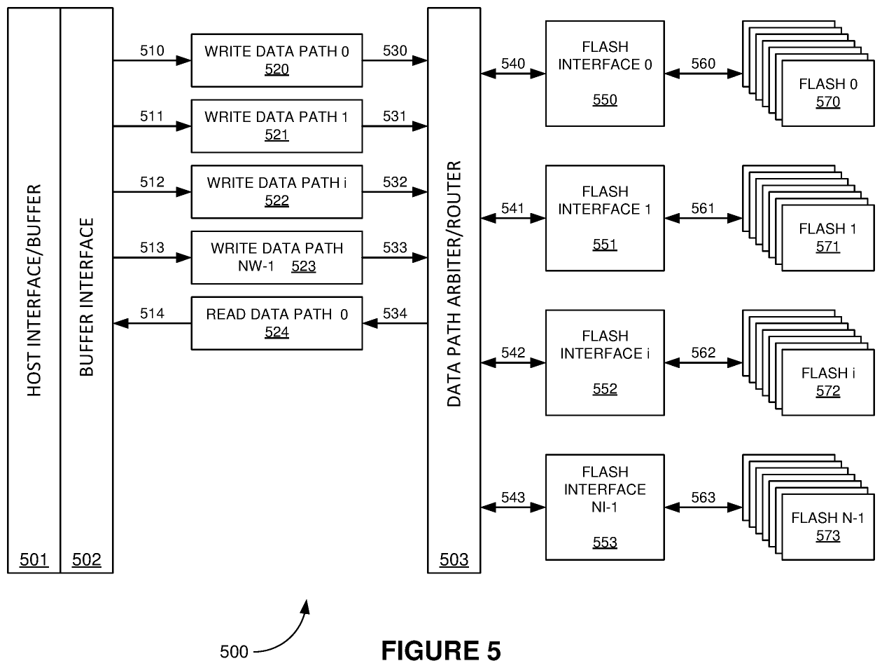

FIG. 5 illustrates an example data storage system 500. This example embodiment has four flash interfaces and flash memory devices (NI=N=4), but unbalanced quantities of read and write data paths (NW=4, NR=1). This example embodiment may be used in a system where write bandwidth is more important than read bandwidth.

This example system comprises buffer 501, buffer interface 502, a quantity of write data paths 520-523, a read data path 524, a data path arbiter/router 503, a quantity of flash interfaces 550-553, and a quantity of flash memories 570-573.

In this example, buffer 501 is configured to communicate with a host system, such as host system 110 from FIG. 1. Buffer interface 502 provides outputs to write data paths 0-NW−1 (520-523) over links 510-513, and receives inputs from read data path 0 524 over link 514. Write data paths 0-NW−1 520-523 send data to arbiter 503 over links 530-533, and read data path 0 524 receives data from arbiter 503 over link 534. Arbiter 503 communicates with flash interfaces 0-NI−1 550-553 over links 540-543. Flash interfaces 0-NI−1 550-553 communicate with flash memory devices 0-N−1 570-573 over links 560-563 respectively.

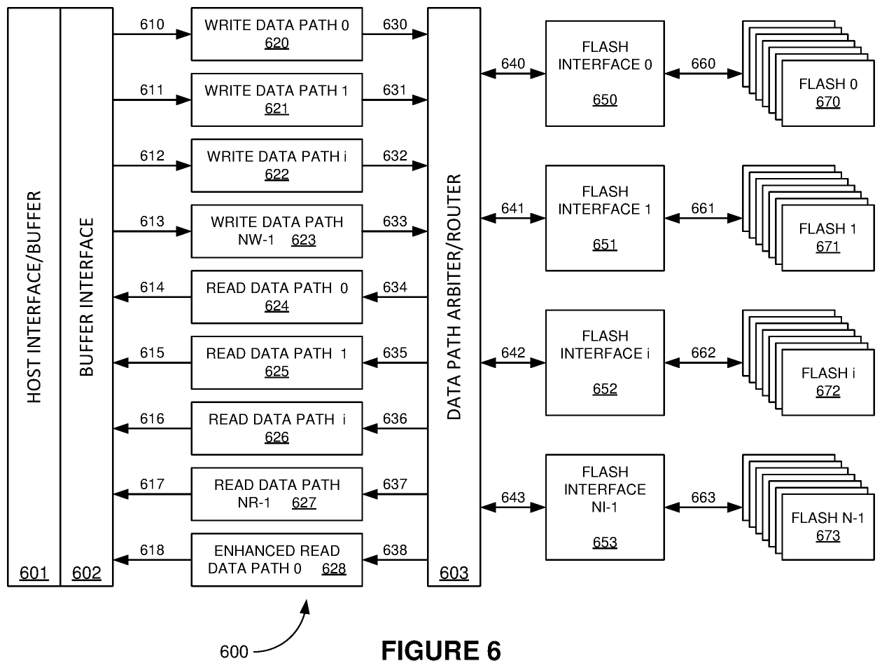

FIG. 6 illustrates an example data storage system 600. This example embodiment has four flash interfaces and flash memory devices (NI=N=4), balanced quantities of read and write data paths (NW=4, NR=4), and an additional enhanced read data path. This example embodiment may be used in a system where some data read from the memory may require enhanced error detection and correction.

This example system comprises buffer 601, buffer interface 602, a quantity of write data paths 620-623, a quantity of read data paths 624-627, an enhanced read data path 628, a data path arbiter/router 603, a quantity of flash interfaces 650-653, and a quantity of flash memories 670-673.

In this example, buffer 601 is configured to communicate with a host system, such as host system 110 from FIG. 1. Buffer interface 602 provides outputs to write data paths 0-NW−1 (620-623) over links 610-613, receives inputs from read data paths 0-NR−1 (624-627) over links 614-617, and receives inputs from enhanced read data path 0 628 over link 618. Write data paths 0-NW−1 620-623 send data to arbiter 603 over links 630-633, read data paths 0-NR−1 624-627 receive data from arbiter 603 over links 634-637, and enhanced read data path 0 628 receives data from arbiter 603 over link 638. Arbiter 603 communicates with flash interfaces 0-NI−1 650-653 over links 640-643. Flash interfaces 0-NI−1 650-653 communicate with flash memory devices 0-N−1 670-673 over links 660-663 respectively.

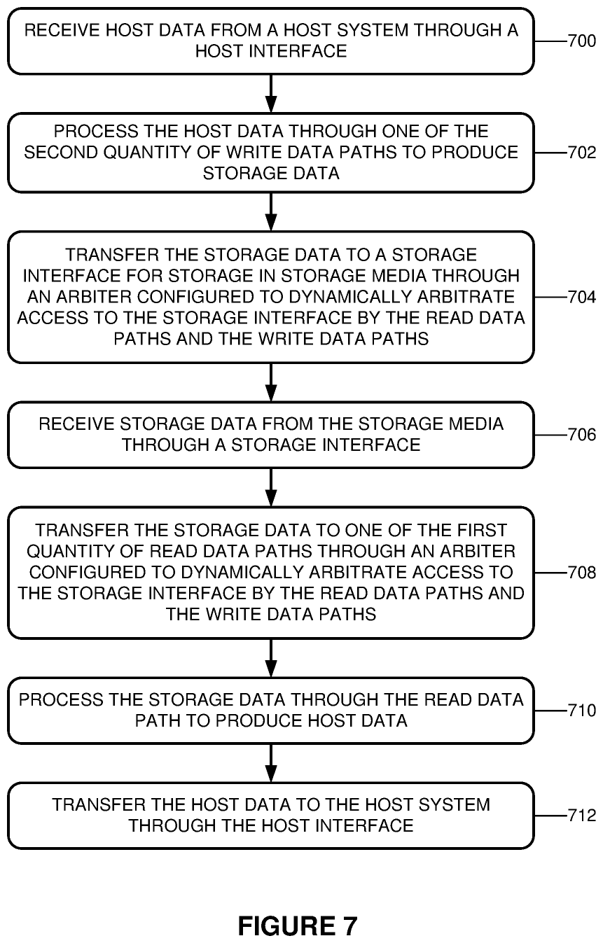

FIG. 7 illustrates an example method for operating a storage controller, such as storage controller 120 from FIG. 1. In this example, operations 700-704 describe a method of writing data from a host system to a storage media within a storage system, while operations 706-712 describe a method of reading data from the storage media within the storage system.

In this example embodiment, a method for operating a storage controller within a storage system is provided. The storage controller includes a plurality of data paths 320-327. The plurality of data paths 320-327 includes a first quantity of read data paths 324-327 configured to interpret data retrieved from a storage media, and a second quantity of write data paths 320-323 configured to prepare data for storage onto the storage media 370-373.

In this example, storage controller 120 receives host data from host system 110 through a host interface, (operation 700). Storage controller 120 then processes the host data through one of the second quantity of write data paths 320-323 to produce storage data, (operation 702).

Storage controller 120 transfers the storage data to a storage interface 350-353 for storage in the storage media 370-373 through an arbiter 303 configured to dynamically arbitrate access to the storage interface 350-353 by the read data paths 324-327 and the write data paths 320-323, (operation 704).

In reading data from the storage media 370-373, storage controller 120 receives storage data from the storage media 370-373 through a storage interface 350-353, (operation 706). Storage controller 120 then transfers the storage data to one of the first quantity of read data paths 324-327 through an arbiter 303 configured to dynamically arbitrate access to the storage interface by the read data paths 324-327 and the write data paths 320-323, (operation 708).

Storage controller 120 then processes the storage data through the read data path 324-327 to produce host data, (operation 710). Storage controller 120 transfers the host data to a host system 110 through a host interface, (operation 712).

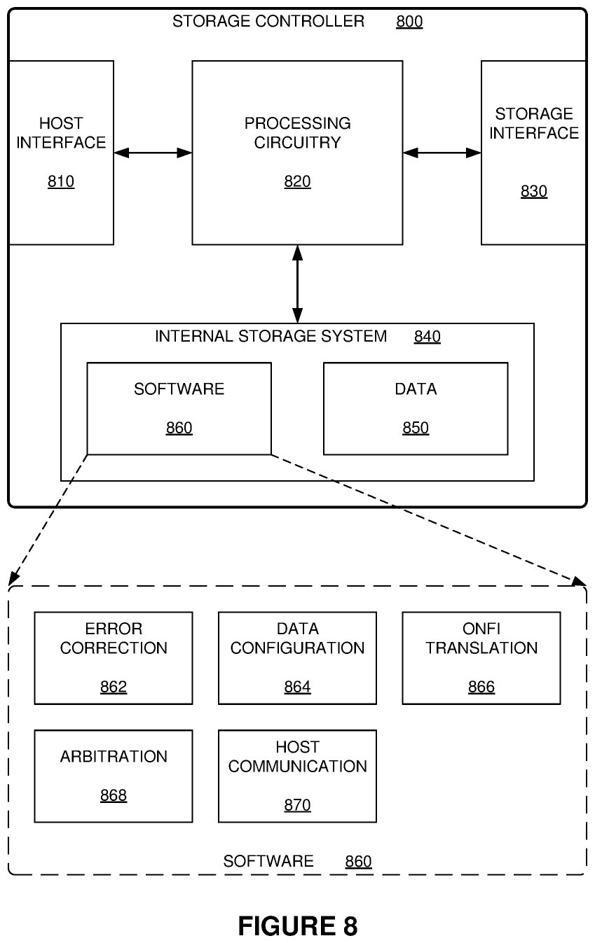

FIG. 8 illustrates storage controller 800, such as storage controller 120 from FIG. 1. As discussed above, storage controller 800 may take on any of a wide variety of configurations. Here, an example configuration is provided for a storage controller implemented as an ASIC. However, in other examples, storage controller 800 may be built into a storage system or storage array, or into a host system.

In this example embodiment, storage controller 800 comprises host interface 810, processing circuitry 820, storage interface 830, and internal storage system 840. Host interface 810 comprises circuitry configured to receive data and commands from an external host system and to send data to the host system. In some embodiments, host interface 810 or processing circuitry 820 may include a media emulation layer.

Storage interface 830 comprises circuitry configured to send data and commands to an external storage system and to receive data from the storage system. In some embodiments storage interface 830 may include ONFI ports for communicating with the storage system.

Processing circuitry 820 comprises electronic circuitry configured to perform the tasks of a storage controller as described above. In this example, processing circuitry 820 includes read data paths, write data paths, and an arbiter as described above. Processing circuitry 820 may comprise microprocessors and other circuitry that retrieves and executes software 860. Processing circuitry 820 may be embedded in a storage system in some embodiments. Examples of processing circuitry 820 include general purpose central processing units, application specific processors, and logic devices, as well as any other type of processing device, combinations, or variations thereof. Processing circuitry 820 can be implemented within a single processing device but can also be distributed across multiple processing devices or sub-systems that cooperate in executing program instructions.

Internal storage system 840 can comprise any non-transitory computer readable storage media capable of storing software 860 that is executable by processing circuitry 820. Internal storage system 820 can also include various data structures 850 which comprise one or more databases, tables, lists, or other data structures. Storage system 840 can include volatile and nonvolatile, removable and non-removable media implemented in any method or technology for storage of information, such as computer readable instructions, data structures, program modules, or other data.

Storage system 840 can be implemented as a single storage device but can also be implemented across multiple storage devices or sub-systems co-located or distributed relative to each other. Storage system 840 can comprise additional elements, such as a controller, capable of communicating with processing circuitry 820. Examples of storage media include random access memory, read only memory, magnetic disks, optical disks, flash memory, virtual memory and non-virtual memory, magnetic cassettes, magnetic tape, magnetic disk storage or other magnetic storage devices, or any other media which can be used to store the desired information and that can be accessed by an instruction execution system, as well as any combination or variation thereof.

Software 860 can be implemented in program instructions and among other functions can, when executed by storage controller 800 in general or processing circuitry 820 in particular, direct storage controller 800, or processing circuitry 820, to operate as described herein for a storage controller. Software 860 can include additional processes, programs, or components, such as operating system software, database software, or application software. Software 860 can also comprise firmware or some other form of machine-readable processing instructions executable by elements of processing circuitry 820.

In at least one implementation, the program instructions can include error correction module 862, data configuration module 864, ONFI translation module 866, arbitration module 868, and host communication module 870.

Error correction module 862 includes instructions directing processing circuitry 820 to encode and decode data using error detection and correction codes. Data configuration module 864 provides instructions for the read and write data paths to decode and encode respectively data for storage in the storage media. ONFI translation module 866 translates commands from the host into Open NAND Flash Interface (ONFI) commands for use by a storage system. Arbitration module 868 instructs processing circuitry 820 to dynamically arbitrate access to the one or more storage interfaces by the read data paths and the write data paths. Host communication module 870 interfaces with a host system to provide host data and commands to storage controller 800 for conversion into storage data and commands usable by a storage system.

In general, software 860 can, when loaded into processing circuitry 820 and executed, transform processing circuitry 820 overall from a general-purpose computing system into a special-purpose computing system customized to operate as described herein for a storage controller, among other operations. Encoding software 860 on internal storage system 840 can transform the physical structure of internal storage system 840. The specific transformation of the physical structure can depend on various factors in different implementations of this description. Examples of such factors can include, but are not limited to the technology used to implement the storage media of internal storage system 840 and whether the computer-storage media are characterized as primary or secondary storage.

For example, if the computer-storage media are implemented as semiconductor-based memory, software 860 can transform the physical state of the semiconductor memory when the program is encoded therein. For example, software 860 can transform the state of transistors, capacitors, or other discrete circuit elements constituting the semiconductor memory. A similar transformation can occur with respect to magnetic or optical media. Other transformations of physical media are possible without departing from the scope of the present description, with the foregoing examples provided only to facilitate this discussion.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above may be combined in various ways to form multiple embodiments. As a result, the invention is not limited to the specific embodiments described above, but only by the claims and their equivalents.

What is claimed is:

1. A storage controller for a storage system, comprising:
a host interface, configured to receive data for storage within the storage system, and to transmit data from the storage system to a host system;
one or more storage interfaces, configured to transmit data to storage media within the storage system, and to receive data from the storage media;
a plurality of data paths configured to process and transfer data between the host interface and the one or more storage interfaces, the plurality of data paths comprising a first quantity of read data paths configured to interpret data retrieved from the storage media, and a second quantity of write data paths configured to prepare data for storage onto the storage media; and
an arbiter configured to dynamically arbitrate access to the one or more storage interfaces by the read data paths and the write data paths.

2. The storage controller of claim 1, wherein the first quantity of read data paths is equal to the second quantity of write data paths.

3. The storage controller of claim 1, wherein the first quantity of read data paths is greater than the second quantity of write data paths.

4. The storage controller of claim 1, wherein the first quantity of read data paths is less than the second quantity of write data paths.

5. The storage controller of claim 1, wherein the plurality of data paths further comprises a third quantity of enhanced read data paths.

6. The storage controller of claim 1, wherein the read data paths are configured to process data from the one or more storage interfaces by undoing randomization, deinterleaving, detecting errors, correcting errors, or removing padding.

7. The storage controller of claim 1, wherein the write data paths are configured to process data from the host interface by randomizing, interleaving, encoding error detection, encoding error correction, or padding.

8. The storage controller of claim 1, wherein the enhanced read data paths are configured to process data from the one or more storage interfaces by performing enhanced error detection or correction.

9. The storage controller of claim 8, wherein the enhanced read data paths are configured to perform Low-Density Parity Check error correction using soft inputs with enhanced internal precision.

10. The storage controller of claim 1, wherein the arbiter is further configured to provide priority to a portion of the one or more storage interfaces.

11. A method of operating a storage controller for a storage system, the storage controller comprising a plurality of data paths, the plurality of data paths comprising a first quantity of read data paths configured to interpret data retrieved from a storage media within the storage system, and a second quantity of write data paths configured to prepare data for storage onto the storage media, the method comprising:
receiving host data from a host system through a host interface;
processing the host data through one of the second quantity of write data paths to produce storage data; and
transferring the storage data to a storage interface for storage in the storage media through an arbiter configured to dynamically arbitrate access to the storage interface by the read data paths and the write data paths.

12. The storage controller of claim 11, wherein the first quantity of read data paths is equal to the second quantity of write data paths.

13. The storage controller of claim 11, wherein the first quantity of read data paths is greater than the second quantity of write data paths.

14. The storage controller of claim 11, wherein the first quantity of read data paths is less than the second quantity of write data paths.

15. The storage controller of claim 11, wherein the plurality of data paths further comprises a third quantity of enhanced read data paths.

16. The storage controller of claim 11, wherein the read data paths are configured to process data from the one or more storage interfaces by undoing randomization, deinterleaving, detecting errors, correcting errors, or removing padding.

17. The storage controller of claim 11, wherein the write data paths are configured to process data from the host interface by randomizing, interleaving, encoding error detection, encoding error correction, or padding.

18. The storage controller of claim 11, wherein the enhanced read data paths are configured to process data from the one or more storage interfaces by performing enhanced error detection or correction.

19. The storage controller of claim 18, wherein the enhanced read data paths are configured to perform Low-Density Parity Check error correction using soft inputs with enhanced internal precision.

20. A method of operating a storage controller for a storage system, the storage controller comprising a plurality of data paths, the plurality of data paths comprising a first quantity of read data paths configured to interpret data retrieved from a storage media within the storage system, and a second quantity of write data paths configured to prepare data for storage onto the storage media, the method comprising:
receiving storage data from the storage media through a storage interface;
transferring the storage data to one of the first quantity of read data paths through an arbiter configured to dynamically arbitrate access to the storage interface by the read data paths and the write data paths;
processing the storage data through the read data path to produce host data; and
transferring the host data to a host system through a host interface.
